(19) United States
(12) Patent Application Publication
(10) Pub. No.: US 2024/0196316 A1
(43) Pub. Date: Jun. 13, 2024

(54) SYSTEMS AND METHODS FOR INHOMOGENEOUS SLICE SUPPORT

(71) Applicant: Telefonaktiebolaget LM Ericsson (publ), Stockholm (SE)

(72) Inventors: Peter Hedman, Helsingborg (SE); Angelo Centonza, Granada (ES); Ylva Timner, Luleå (SE); Håkan Palm, Växjö (SE); Paul Schliwa-Bertling, Ljungsbro (SE)

(21) Appl. No.: 18/277,252

(22) PCT Filed: Feb. 18, 2022
(86) PCT No.: PCT/IB2022/051482

§ 371 Date: Aug. 15, 2023

Related U.S. Application Data
(60) Provisional application No. 63/150,872, filed on Feb. 18, 2021.

(51) Int. Cl. H04W 48/18; H04W 60/00

(52) U.S. Cl. CPC H04W 48/18; H04W 60/00

(57) ABSTRACT

Systems and methods for inhomogeneous slice support are provided. In some embodiments, a wireless device: signals an indication that it supports non-uniform slice availability and receives an information on how it may act based on the indicated slice support. In this way, some embodiments allow the Radio Access Network (RAN) and/or CN to correctly handle legacy and new UE types in a system where new UEs may be able to support non uniform slice availability. These may enable the CN to manage the legacy UEs in a way that their legacy behavior does not create unnecessary slice requests, e.g., for slices that are not available in a given cell. These systems and methods may allow new UEs to be configured with information for allowed slices that are not uniformly available, and that the UE may access upon detection of information expressing availability of such slices in a given cell/Tracking Area.

### RELATED APPLICATIONS

This application is a 35 U.S.C. § 371 national phase filing of International Application No. PCT/IB2022/051482, filed Feb. 18, 2022, which claims the benefit of provisional patent application Ser. No. 63/150,872, filed Feb. 18, 2021, the disclosures of which are hereby incorporated herein by reference in their entireties.

### TECHNICAL FIELD

The present disclosure relates to accessing a network slice.

### BACKGROUND

The current 5G RAN architecture is described in 3GPP TS 38.401 and is shown in FIG. 1. The NG architecture can be further described as follows:
The NG-RAN consists of a set of eNBs and gNBs connected to the 5GC through the NG.
An eNB/gNB can support FDD mode, TDD mode or dual mode operation.
eNB/gNBs can be interconnected through the Xn.
A gNB may consist of a gNB-CU and gNB-DUs.
A gNB-CU and a gNB-DU are connected via F1 logical interface.
One gNB-DU is connected to only one gNB-CU.

NG, Xn and F1 are logical interfaces. For NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In NG-Flex configuration, each gNB is connected to all AMFs within an AMF Region. The AMF Region is defined in 3GPP TS 23.501.

There currently exist certain challenge(s). Network slicing is about creating logically separated partitions of the network, addressing different business purposes. These “network slices” are logically separated to a degree that they can be regarded and managed as networks of their own.

This is a new concept that potentially applies to both LTE Evolution and new 5G RAT (NR). The key driver for introducing network slicing is business expansion, i.e., improving the cellular operator's ability to serve other industries, e.g., by offering connectivity services with different network characteristics (performance, security, robustness, and complexity).

The current working assumption is that there will be one shared Radio Access Network (RAN) infrastructure that will connect to several CN instances (with one or more Common Control NW Functions (CCNF) interfacing the RAN, plus additional CN functions which may be slice-specific). As the CN functions are being virtualized, it is assumed that the operator shall instantiate a new Core Network (CN), or part of it, when a new slice should be supported. This architecture is shown in FIG. 2. Slice 0 can for example be a Mobile Broadband slice and Slice 1 can for example be a Machine Type Communication network slice.

### SUMMARY

Systems and methods for inhomogeneous slice support are provided. In some embodiments, a method performed by a wireless device for inhomogeneous slice support includes: signaling, to a Core Network (CN) node, an indication that the wireless device supports non-uniform slice availability; and receiving an information on how the wireless device may act based on the indicated slice support. In this way, some embodiments allow the RAN and CN to correctly handle legacy and new UE types in a system where new UEs may be able to support non uniform slice availability. This method enables the CN to manage the legacy UEs in a way that their legacy behavior does not create unnecessary slice requests, e.g., for slices that are not available in a given cell. At the same time, the methods allow new UEs to be configured with information for allowed slices that are not uniformly available, and that the UE may access upon detection of information expressing availability of such slices in a given cell/TA.

In some embodiments, each cell indicates to the UE which slices are supported by the cell. In some embodiments, information on how the UE may act based on the indicated slice support is signaled to the UE.

In another embodiment, the UE signals to the CN, upon performing NAS registration, an indication that it supports non-uniform slice availability. Such indication can be signaled in a number of ways, such as: as part of NAS signaling from the UE to CN, and transparently to the RAN; as part of AS signaling, e.g., via RRC signaling, from UE to RAN and then forwarded from RAN to CN via the common RAN-CN interface, e.g., the NG interface.

This indication may be represented in a number of ways, such as: the capability of the UE to support broadcast information on slices or group of slices served by a specific cell or radio coverage layer or frequency layer; the capability of the UE to support non uniform slice availability and by that of not requesting access to slices or services on the slice in those areas (e.g., cells) within the RA, where the slice is not available.

Upon reception of such indication, the CN performs a number of actions such as: assign an appropriate Allowed Network Slice Selection Assistance Information (NSSAI) to the UE. If the UE supports non uniform slice availability, the CN may include in the Allowed NSSAI also slices that are not uniformly available within the RA. If the UE only supports uniform slice availability, the CN may include in the Allowed NSSAI only slices that are uniformly available within the RA.

In a third embodiment, we provide details on means to control a UE to provide a reference to a group of Slices (RRSG) at RRC Connection establishment and for Network to verify UE used correct RRSG.

There are, proposed herein, various embodiments which address one or more of the issues disclosed herein.
1. The NG-RAN and the AMFs exchange the support of S-NSSAIs as per current TS 38.413; NG-RAN could provide the list of RRSG supported by the NG-RAN node per Tracking Area (TA), and optionally per S-NSSAI, and then AMF could provide these to NSSF. This may be done to avoid the need for AMF/NSSF to get same info via O&M.
2. The UE performs network selection as per current means.
3. The UE sends a Registration Request indicating that the UE supports RRSG functionality, but without any Requested NSSAI as the UE has no slicing configuration for the PLMN.
4. The NG-RAN forwards the NAS message to the selected AMF.
5. The AMF and, if supported, the NSSF performs Network Slice selection. AMF sends the Nssf_NSSelection request to the NSSF. Optionally the request indicates that RRSG is supported i.e., both the UE and the AMF supports RRSG (the information can be provided as a parameter in the Nssf_NSSelection service operation message payload or using the feature negotiation mechanism specified in clause 6.6 of 3GPP TS 29.500).
6. The NSSF response includes Allowed NSSAI and Configured NSSAI as per current specifications, but if RRSG is not supported by the AMF (and UE) the NSSF does not provide S-NSSAIs that are supported with RRSG in the response e.g., in Allowed NSSAI and Configured NSSAI.
7. The AMF sends the Registration Accept to the UE via NG-RAN as per current procedures and includes the Allowed NSSAI to the UE. The AMF may signal to the UE (that supports RRSG functionality) also the list of RRSG per S-NSSAI.
   The AMF may also indicate in the Access Stratum Connection Establishment NSSAI Inclusion Mode that the UE is to indicate RRSG during the RRC Connection Establishment.
   The UE stores the received information.

Moreover, the solution allows for a distinction in the level of support for a slice within a cell. A UE can therefore better determine how to select a cell, when in need of requesting services for a given slice. The UE can select the cell if the slice to be requested is “Allowed or Preferred. If a cell where the slice is neither allowed or preferred is available for selection, the UE may still select a cell where the slice to be requested is “not preferred” and be served for that slice. This ensures a better service availability.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a current Fifth Generation (5G) Radio Access Network (RAN) architecture;

FIG. 2 illustrates how Core Network (CN) functions are being virtualized;

FIG. 3 illustrates one example of a cellular communications system in which embodiments of the present disclosure may be implemented;

FIG. 4 illustrates a wireless communication system represented as a 5G network architecture composed of core Network Functions (NFs), where interaction between any two NFs is represented by a point-to-point reference point/interface;

FIG. 5 illustrates a 5G network architecture using service-based interfaces between the NFs in the CP, instead of the point-to-point reference points/interfaces used in the 5G network architecture of FIG. 4;

FIGS. 6A, 6B, and 7 illustrate methods performed by a wireless device for inhomogeneous slice support, according to some embodiments of the present disclosure;

FIG. 8 illustrates a method performed by a base station or network node for inhomogeneous slice support, according to some embodiments of the present disclosure;

FIG. 9 illustrates an example where the term “Support RRSG” is equivalent to “support of non-uniform slice availability”, according to some embodiments of the present disclosure;

FIG. 10 illustrates additional details of some embodiments;

FIG. 11 is a schematic block diagram of a radio access node according to some embodiments of the present disclosure;

FIG. 12 is a schematic block diagram that illustrates a virtualized embodiment of the radio access node according to some embodiments of the present disclosure;

FIG. 13 is a schematic block diagram of the radio access node according to some other embodiments of the present disclosure;

FIG. 14 is a schematic block diagram of a wireless communication device 1400 according to some embodiments of the present disclosure;

FIG. 15 is a schematic block diagram of the wireless communication device 1400 according to some other embodiments of the present disclosure;

FIG. 16 illustrates a communication system includes a telecommunication network, such as a 3GPP-type cellular network, which comprises an access network, such as a RAN, and a core network, according to some embodiments of the present disclosure;

FIG. 17 illustrates the UE, base station, and host computer, according to some embodiments of the present disclosure; and

FIGS. 18 through 21 are flowcharts illustrating a method implemented in a communication system, in accordance with one embodiment.

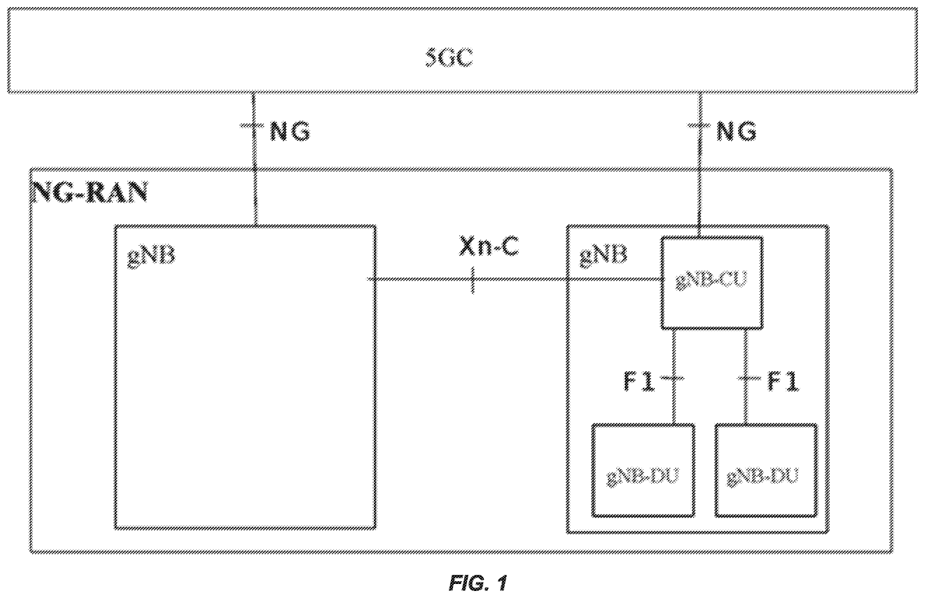

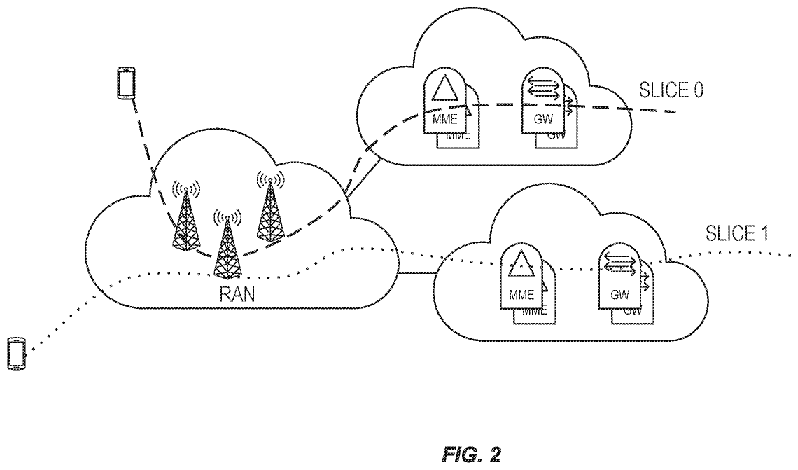

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

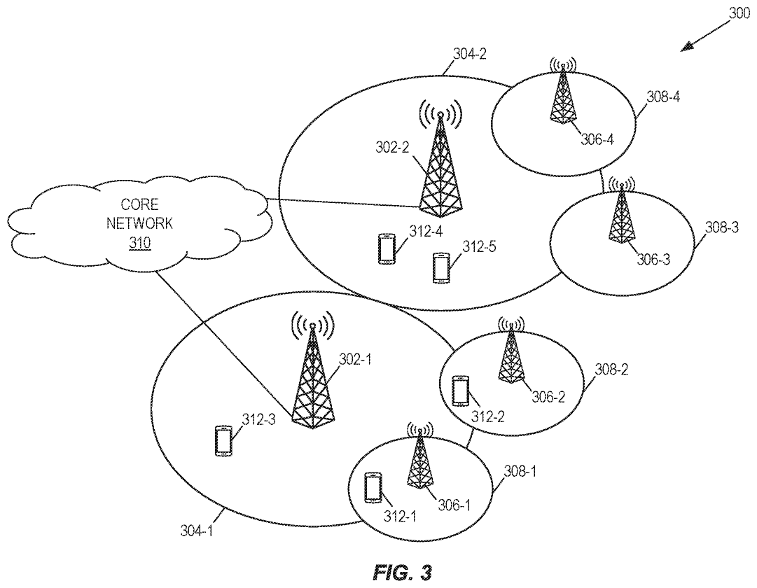

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 302-1 and 302-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5G System (5GS) is referred to as the 5GC. The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs, but the present disclosure is not limited thereto.

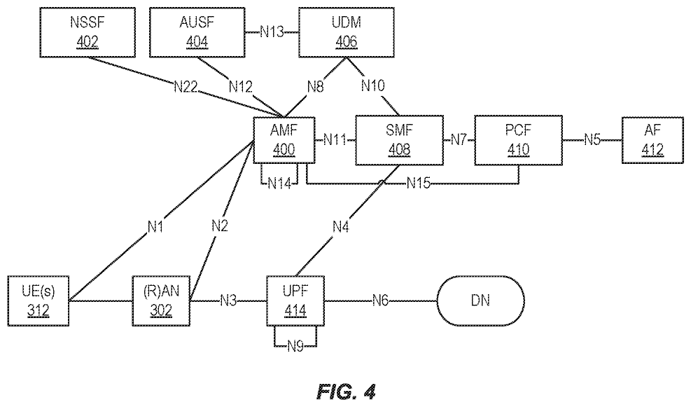

FIG. 4 illustrates a wireless communication system represented as a 5G network architecture composed of core Network Functions (NFs), where interaction between any two NFs is represented by a point-to-point reference point/interface. FIG. 4 can be viewed as one particular implementation of the system 300 of FIG. 3.

Seen from the access side the 5G network architecture shown in FIG. 4 comprises a plurality of UEs 312 connected to either a RAN 302 or an Access Network (AN) as well as an AMF 400. Typically, the R(AN) 302 comprises base stations, e.g., such as eNBs or gNBs or similar. Seen from the core network side, the 5GC NFs shown in FIG. 4 include a NSSF 402, an AUSF 404, a UDM 406, the AMF 400, a SMF 408, a PCF 410, and an Application Function (AF) 412.

Reference point representations of the 5G network architecture are used to develop detailed call flows in the normative standardization. The N1 reference point is defined to carry signaling between the UE 312 and AMF 400. The reference points for connecting between the AN 302 and AMF 400 and between the AN 302 and UPF 414 are defined as N2 and N3, respectively. There is a reference point, N11, between the AMF 400 and SMF 408, which implies that the SMF 408 is at least partly controlled by the AMF 400. N4 is used by the SMF 408 and UPF 414 so that the UPF 414 can be set using the control signal generated by the SMF 408, and the UPF 414 can report its state to the SMF 408. N9 is the reference point for the connection between different UPFs 414, and N14 is the reference point connecting between different AMFs 400, respectively. N15 and N7 are defined since the PCF 410 applies policy to the AMF 400 and SMF 408, respectively. N12 is required for the AMF 400 to perform authentication of the UE 312. N8 and N10 are defined because the subscription data of the UE 312 is required for the AMF 400 and SMF 408.

The 5GC network aims at separating UP and CP. The UP carries user traffic while the CP carries signaling in the network. In FIG. 4, the UPF 414 is in the UP and all other NFs, i.e., the AMF 400, SMF 408, PCF 410, AF 412, NSSF 402, AUSF 404, and UDM 406, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round-Trip Time (RTT) between UEs and data network for some applications requiring low latency.

The core 5G network architecture is composed of modularized functions. For example, the AMF 400 and SMF 408 are independent functions in the CP. Separated AMF 400 and SMF 408 allow independent evolution and scaling. Other CP functions like the PCF 410 and AUSF 404 can be separated as shown in FIG. 4. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

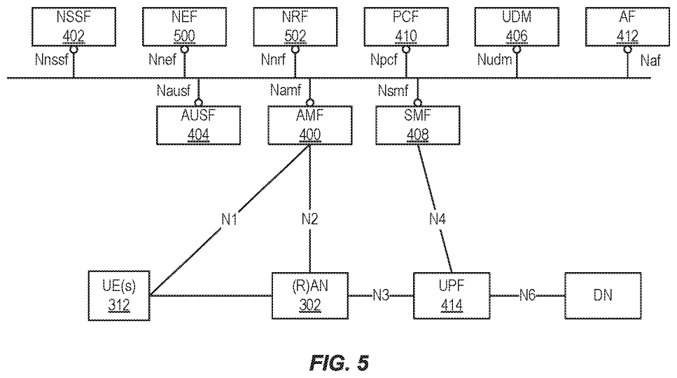

FIG. 5 illustrates a 5G network architecture using service-based interfaces between the NFs in the CP, instead of the point-to-point reference points/interfaces used in the 5G network architecture of FIG. 4. However, the NFs described above with reference to FIG. 4 correspond to the NFs shown in FIG. 5. The service(s) etc. that a NF provides to other authorized NFs can be exposed to the authorized NFs through the service-based interface. In FIG. 5 the service-based interfaces are indicated by the letter “N” followed by the name of the NF, e.g., Namf for the service-based interface of the AMF 400 and Nsmf for the service-based interface of the SMF 408, etc. The NEF 500 and the NRF 502 in FIG. 5 are not shown in FIG. 4 discussed above. However, it should be clarified that all NFs depicted in FIG. 4 can interact with the NEF 500 and the NRF 502 of FIG. 5 as necessary, though not explicitly indicated in FIG. 4.

Some properties of the NFs shown in FIGS. 4 and 5 may be described in the following manner. The AMF 400 provides UE-based authentication, authorization, mobility management, etc. A UE 312 even using multiple access technologies is basically connected to a single AMF 400 because the AMF 400 is independent of the access technologies. The SMF 408 is responsible for session management and allocates Internet Protocol (IP) addresses to UEs. It also selects and controls the UPF 414 for data transfer. If a UE 312 has multiple sessions, different SMFs 408 may be allocated to each session to manage them individually and possibly provide different functionalities per session. The AF 412 provides information on the packet flow to the PCF 410 responsible for policy control in order to support QoS. Based on the information, the PCF 410 determines policies about mobility and session management to make the AMF 400 and SMF 408 operate properly. The AUSF 404 supports authentication function for UEs or similar and thus stores data for authentication of UEs or similar while the UDM 406 stores subscription data of the UE 312. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

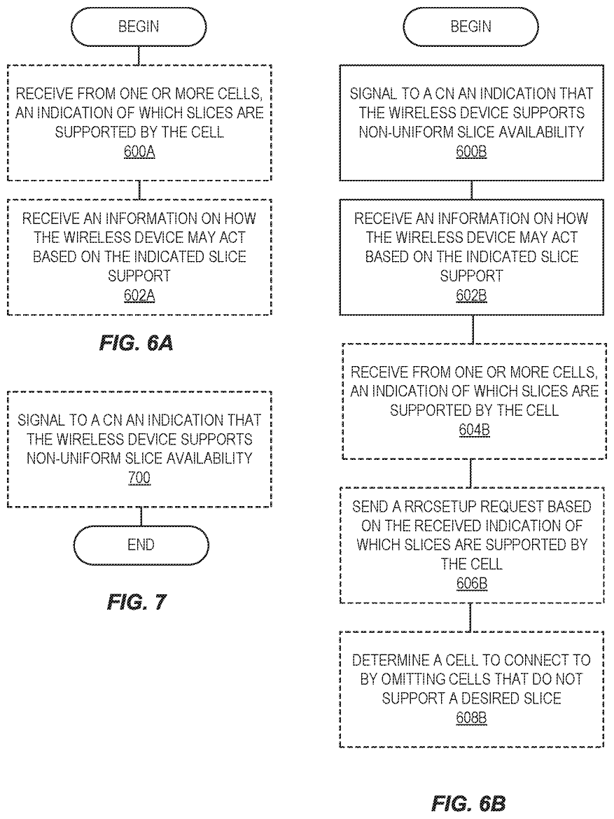

FIGS. 6A, 6B, and 7 illustrate methods performed by a wireless device for inhomogeneous slice support, according to some embodiments of the present disclosure. FIG. 6A illustrates a method where a wireless device receives, from one or more cells, an indication of which slices are supported by the cell (step 600A); and receives information on how the wireless device may act based on the indicated slice support (step 602A).

FIG. 6B illustrates a method where a wireless device signals, to a CN node, an indication that the wireless device supports non-uniform slice availability (step 600B); and receives information on how the wireless device may act based on the indicated slice support (602B). The wireless device optionally receives, from one or more cells, an indication of which slices are supported by the cell (step 604B). The wireless device optionally sends a RRCSetup request based on the received indication of which slices are supported by the cell (step 606B). The wireless device optionally determines a cell to connect to by omitting cells that do not support a desired slice (step 608B).

FIG. 7 illustrates a method where a wireless device optionally signals, to a CN node, an indication that the wireless device supports non-uniform slice availability (step 700).

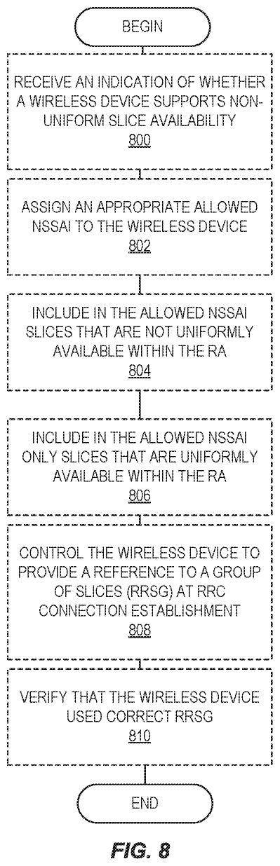

FIG. 8 illustrates a method performed by a base station or network node for inhomogeneous slice support, according to some embodiments of the present disclosure.

### Details Related to Supporting Legacy UEs

Below a description of the methods and procedures performed by each part of the system is provided.

### Embodiments Relative to the UE:

In one embodiment, the UE performs network selection, e.g., by means of the cell reselection criteria configured previously at the UE or retrieved from broadcast information.

Once the UE is connected to a RAN node, the UE signals a NAS Registration Request, requesting access to a network slice identified by an S-NSSAI. The UE includes together with this request an indication of whether it is able to support non uniform slice availability.

In another embodiment, the UE, upon gaining connection to a RAN node, signals over RRC an indication that the UE supports non uniform slice availability. Such indication may be signaled over the so called Msg3 (namely the first scheduled transmission of the random access procedure) or over the so called Msg5, e.g., RRC Setup Complete message. The RAN node receiving such indication forwards it to the CN serving the UE by means of RAN-CN signaling, e.g., via the NG interface.

Upon receiving from the CN an Allowed NSSAI listing the Single—NSSAI (S-NSSAI) that the UE can access within the RA, the UE will be able to request access to the slices in the Allowed NSSAI, whenever they are available at the RAN node or cell serving the UE.

### Embodiments Relative to the Serving CN:

In one embodiment the CN receives from the UE or from the RAN serving the UE, an indication that the UE is able to support non uniform slice availability. The CN therefore assigns to the UE a list of allowed slices, also known as an Allowed NSSAI, that includes
only slices that are uniformly available within the RA, if the UE is not able to support non uniform slice availability identified by the absence of the indication that the UE is able to support non uniform slice availability
Both type of slices, i.e., slices that are uniformly available and slices that are not uniformly available within the RA.

The CN signals the Allowed NSSAI assigned to the UE, in accordance to the UE capabilities to support non uniform slice availability, via NAS signaling, e.g., in NAS Registration Accept.

CN also signals the Allowed NSSAI to the RAN. Additionally, the CN may signal to the RAN an indication of the preferred (or prioritised) frequency layer to be selected to access the slices the UE has requested. Such indication may be provided by means of signaling the RAT-Frequency Priority Information, in the form of the Subscriber Profile ID for RAT/Frequency priority IE or the Index to RAT/Frequency Selection Priority IE, or any similar indication allowing the RAN to deduce priority levels for radio resources with respect to the slice requested by the UE.

### Embodiments Relative to the Serving RAN:

In one embodiment the serving RAN node receives from the UE, over RRC signaling, an indication of whether the UE supports non uniform slice availability. The RAN will forward such indication to the CN over the RAN-CN interface. For example, the RAN will signal such indication of support for non-uniform slice availability as part of the NG: Initial UE Message.

The RAN receives from the CN an Allowed NSSAI which is assigned on the basis of whether the UE supports non uniform slice availability or not.

The RAN is able to deduce whether the UE supports non uniform slice availability in one or more of the following possible ways:
By means of checking the slices included in the Allowed NSSAI. If such slices are not uniformly available, the RAN may deduce that the UE supports non uniform slice availability.
By means of receiving from CN an indication, together with the Allowed NSSAI signalled to the RAN, of whether the UE supports non uniform slice availability
By checking the UE capabilities and verifying that the UE supports a capability for non-uniform slice availability support

Upon knowing that the UE supports or not non uniform slice availability, the RAN may handle the UE differently. For example:
The RAN may trigger UE mobility towards cells where only uniform availability slices are supported
Depending on whether the UE is capable or not to connect to cells where a slice is served with full QoS (i.e., whether the UE is able to support non uniform slice availability where slice availability is also differentiated with respect to QoS per service), the RAN may decide to serve the UE with specific QoS configurations per service, if the slice the UE wants to access cannot be served with full QoS in the cell where the UE is connected.

In another embodiment a UE supporting non uniform slice availability performs RRC Resume procedure in a cell where only a subset of slices in use by the UE before entering the RRC Inactive state are available.

At the RRC Resume procedure, RAN verifies if UE's context stored in RAN includes PDU Session(s) and DRB(s) associated with slices that are not available in this serving cell.

In one embodiment, if PDU Session(s) and DRB(s) associated with slices not available in this serving cell are determined to be included in UE's context, the RAN indicates in the PDU Session Management signaling to the SMF(s) handling these PDU Session(s) that these PDU Session(s) are no longer available and provides the applicable cause value. The RAN removes the resources associated with that PDU Session(s). The SMF(s) indicate to the UPF(s) that the GTP-U tunnel(s) associated with that PDU Session(s) is removed. The RAN reconfigures the UE and removes from the RRC configuration the DRB(s) associated with PDU Session(s) that are associated with slices that are not available in this cell.

In another embodiment, if PDU Session(s) and DRB(s) associated with slices not available in this serving cell are determined to be included in UE's context, the RAN indicates in the PDU Session Management signaling to the SMF(s) handling these PDU Session(s) that these PDU Session(s) are suspended, i.e., are temporarily not available for data transfer and provides the applicable cause value. The RAN reconfigures the UE and indicates to the UE that the DRB(s) associated with PDU Session(s) that are associated with slices that are not available in this cell are currently suspended, i.e., temporarily not available for data traffic. The UE marks these DRB(s) and related configured resources as not available for traffic and provides indication to the upper layers that these access stratum resources are temporarily not available for traffic.

In another embodiment a UE supporting non uniform slice availability performs RRC Resume procedure in a cell where a different set of slices are available compared to the cell where UE has been moved into RRC Inactive state last time, i.e., by last serving cell compared to UE's Allowed NSSAI.

At the RRC Resume procedure, RAN verifies if UE's context stored in RAN includes suspended PDU Session(s) and suspended DRB(s) associated with slices that are available in this serving cell.

In another embodiment, if suspended PDU Session(s) and DRB(s) associated with slices that are available in this serving cell are determined to be included in UE's context, the RAN indicates in the PDU Session Management signaling to the SMF(s) handling these PDU Session(s) that these PDU Session(s) are no longer suspended, i.e., are re-activated and available for data transfer and provides the applicable cause value. The RAN reconfigures the UE and indicates to the UE that the DRB(s) associated with re-activated PDU Session(s) are available for data traffic.

In one embodiment the support for non-uniform slice availability is achieved by supporting Radio resource Slice Groups (RRSGs). A RRSG is a group of slices identified by their S-NSSAI, which is only supported in parts of the RA assigned to the UE. RRSGs are identified by an RSSG identifier. If the group of slices identified by the RRSG ID is supported in a cell, that cell broadcasts the corresponding RSSG ID.

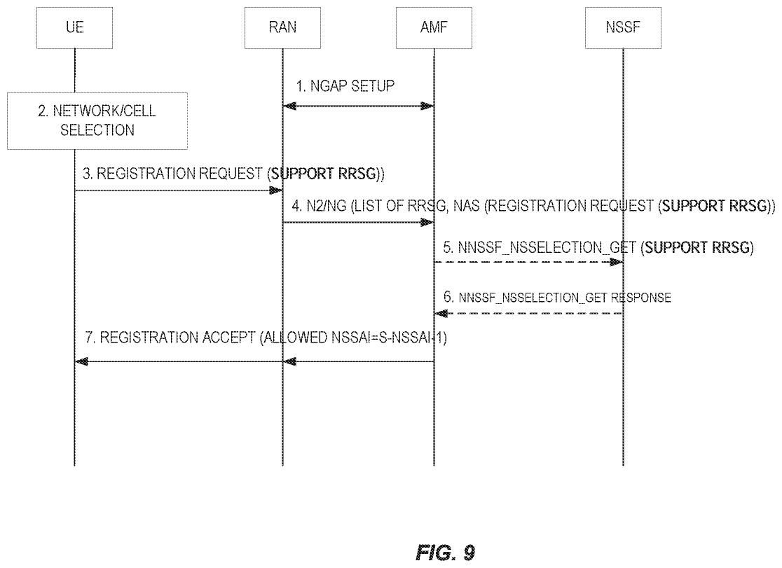

In the FIG. 9 below, an example of the embodiments above is represented. In this figure the term “Support RRSG” is equivalent to “support of non-uniform slice availability”. The following is a description of the steps in the FIG. 9.

Step 1: The NG-RAN and the AMFs exchange the support of S-NSSAIs as per current TS 38.413; NG-RAN could provide the list of RRSG supported by the NG-RAN node per Tracking Area (TA), and optionally per S-NSSAI, and then AMF could provide these to NSSF. This may be done to avoid the need for AMF/NSSF to get same info via O&M.

Step 2: The UE performs network selection as per current means.

Step 3: The UE sends a Registration Request indicating that the UE supports RRSG functionality, but without any Requested NSSAI as the UE has no slicing configuration for the PLMN.

Step 4: The NG-RAN forwards the NAS message to the selected AMF.

Step 5: The AMF and, if supported, the NSSF performs Network Slice selection. AMF sends the Nssf_NSSelection request to the NSSF. Optionally the request indicates that RRSG is supported i.e., both the UE and the AMF supports RRSG (the information can be provided as a parameter in the Nssf_NSSelection service operation message payload or using the feature negotiation mechanism specified in clause 6.6 of 3GPP TS 29.500).

Step 6: The NSSF response includes Allowed NSSAI and Configured NSSAI as per current specifications, but if RRSG is not supported by the AMF (and UE) the NSSF does not provide S-NSSAIs that are supported with RRSG in the response e.g., in Allowed NSSAI and Configured NSSAI.

Step 7: The AMF sends the Registration Accept to the UE via NG-RAN as per current procedures and includes the Allowed NSSAI to the UE. The AMF may signal to the UE (that supports RRSG functionality) also the list of RRSG per S-NSSAI.

The AMF may also indicate in the Access Stratum Connection Establishment NSSAI Inclusion Mode that the UE is to indicate RRSG during the RRC Connection Establishment.

In some embodiments, the UE stores the received information.

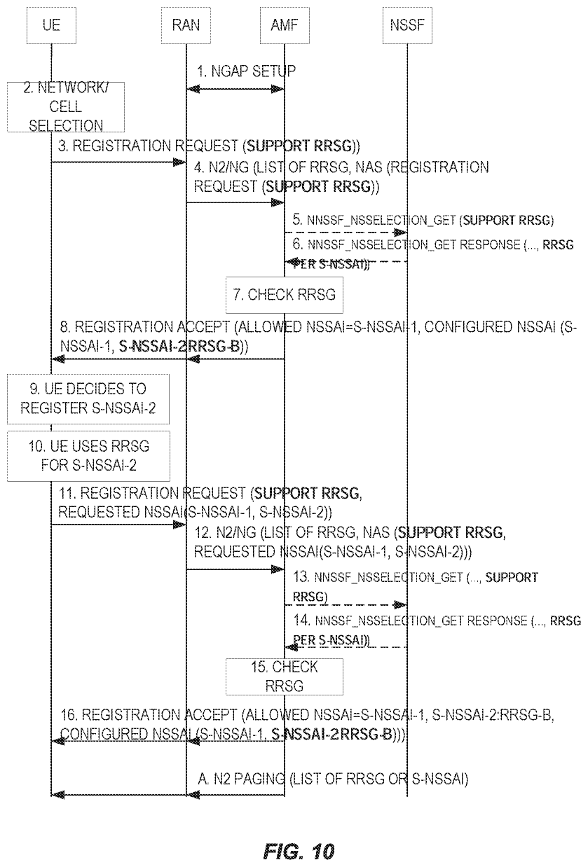

FIG. 10 illustrates additional details of some embodiments. Additional details of these steps can be found below.

Details Related to Controlling UE Behavior when Slice Support is not Homogenous.

Some alternative UE behaviors for a UE that want to access a slice which the cell is not indicating support of:
UE may not access the cell in order to request service on a slice not supported in the cell.
UE may access the cell in order to request to add the slice to the Allowed NSSAI, but it may not request a PDU session on the slice.
UE may access the cell and request a PDU session on the slice, if it is not able to connect to another cell that supports the slice.

Some alternative UE behaviors when it is in Inactive mode and has a PDU session on a slice 1.:
UE may only camp on cells broadcasting support of slice 1.
UE may camp on a cell not broadcasting support of slice 1, if no other cell is available, but it must go to Connected Mode directly after selecting the cell, so that RAN may remove or re-map the PDU session on slice 1.
UE may camp on a cell not broadcasting support of slice 1, if no other cell is available.

Some alternatives for signaling the UE behavior to the UE are:
UE is configured with the expected behavior per slice in the Supported NSSAI by the CN.
At registration, UE is informed of expected behavior in the registration area (RA) for each slice in the Allowed NSSAI.
The Cell broadcasts information of how UE should behave when accessing slices that are not indicated as supported by the Cell.
For each slice/slice group that the cell broadcasts support for, a UE behavior indicator is included, specifying how the UE may access the slice.

Further details on how each cell indicates in system information its capability to provide access to network slices is provided below. The UE uses this information to select the appropriate cell to access the slice.

In the following, the term “slice group” has been used and should be understood as a set of one or several slices that have the same properties with respect to cell support and UE behavior, and is identified with a slice group identity. This is referred to as “RRSG” in “1. Details related to supporting legacy UEs”.
1. For slices grouped in slices group, the cell can indicate per slice group in SIB in this cell
   a. Access to slice in RRSG is allowed in this cell
      i. UE will use this cell to access the slice
   b. Access to slice in slice group not allowed for UE in this cell
      i. UE will re-select to other cell that provides access to the slice, if in coverage.
   c. Access to slice in slice group provided via this cell, but UE should only access the slice via this cell if no other cell/freq that offers access to the slice provides coverage for UE
      i. UE will re-select to other cell that provides access to the slice, if in coverage
2. For slices groped in slice group, but slice group not listed in SIB in this cell, the cell can indicate this information (common for all slices in slice groups but not listed in SIB in this cell)
   a. Access to slice is allowed in this cell
      i. UE will use this cell to access the slice
   b. Access to slice is not allowed in this cell
      i. UE will re-select to other cell that provides access to the slice, if in coverage.
   c. Access to slice in slice group provided via this cell, but UE should only access the slice via this cell if no other cell/freq to access the slice provides coverage for UE
      i. UE will re-select to other cell that provides access to the slice, if in coverage
3. For slices not grouped in slice group, the cell can indicate this information (common for all slices not grouped in slice groups
   a. Access to slice is allowed in this cell
      i. UE will use this cell to access the slice
   b. Access to slice is not allowed in this cell
      i. UE will re-select to other cell that provides access to the slice, if in coverage.
   c. Access to slice in slice group provided via this cell, but UE should only access the slice via this cell if no other cell/freq to access the slice provides coverage for UE
      i. UE will re-select to other cell that provides access to the slice, if in coverage

In another embodiment, the cell slice support information of the first embodiment is provided not via system information, but instead in a dedicated message sent to UE, e.g., RRCConnectionRelease. In this embodiment, the capability to provide access to network slices relate to all cells on a particular frequency, not individual cells (as in first embodiment)

### Details on Means to Control a UE to Provide a Reference to a Group of Slices (RRSG) at RRC Connection Establishment and for Network to Verify UE Used Correct RRSG.

In “1. Details related to supporting legacy UEs”, (FIG. 9, step 7), we explained that the AMF may indicate in the Access Stratum Connection Establishment NSSAI Inclusion Mode that the UE shall indicate RRSG id (slice group identity) during the RRC Connection Establishment (RRCSetupComplete message). According to existing logic (see TS 23.501 clause 5.15.9), UE can be instructed whether to include list of NSSAI in RRC connection establishment. By addition the possibility to instruct the UE to include the RRSG in the RRCSetupComplete message, it is possible for the network at a later UE access to verify that UE used an RRSG that has been assigned to the UE (FIG. 9, step 7). The RAN indicates the RRSG (received by the UE at the RRC Connection establishment) to the AMF and the AMF can verify that the UE used an RRSG that was previously indicated to the UE in the Registration Accept (FIG. 9, step 7).

In some embodiments, OAM configuration may be result of SLA and service prioritization per slice requirements.
In some embodiments, “Code points in SIB in cell” to indicate UE behavior per slice “type”
Slices grouped in RRSG listed in SIB in this cell (code points per listed RRSG)
0—Access to slice in RRSG not provided in this cell
1—Access to slice in RRSG provided via this cell, but UE should only access the slice via this cell if no other cell/freq provides coverage for UE
2—Access to slice in RRSG is not restricted in this cell
Slices groped in RRSG for UE but not listed in SIB in this cell (UE behavior common for all slices in this slice type, code points common for all slices in this slice type)
Access to slice (not in RRSG in SIB) not provided in this cell
Access to slice in RRSG provided via this cell, but UE should only access the slice via this cell if no other cell/frequency provides coverage for UE
Slices not grouped in RRSG for UE (UE behavior common for all slices in this slice type, code points common for all slices in this slice type)
Access to slice (not in RRSG for UE) not provided in this cell
Access to slice (not in RRSG for UE) provided via this cell, but UE should only access the slice via this cell if no other cell/frequency provides coverage for UE
Access to slice in RRSG is not restricted in this cell

In some embodiments, the SIB may include an additional indication whether the RRSG (or list of RRSG) are to be seen as supported by the cell or seen as served by the cell. Supported would mean that only S-NSSAIs associated to the RRSG are allowed to be registered i.e., in Allowed NSSAI (UE will not request such S-NSSAI to be registered) when the UE is using or camping on the cell, while served by the cell means that all S-NSSAIs that NG-RAN indicated as supported for the TA are allowed to be registered i.e., in Allowed NSSAI but dedicated radio resources are only allowed to be used for the S-NSSAIs associated to an RRSG part of the list of RRSG in the SIB.

In some embodiments, a step 7 (between steps 6 and 8) includes AMF may check such that the list of the RRSG of the current cell used by the UE are aligned with the list of RRSG associated to the S-NSSAIs of the Allowed NSSAI.

In some embodiments, NG-RAN could provide the list of RRSG supported by the NG-RAN node per TA and then AMF could provide these to NSSF. Usage could be to avoid the need for AMF/NSSF to get same info via O&M. As SIB may include “supported RRSG” per cell in the sense that only S-NSSAIs with the specific RRSGs are allowed then information whether there are cells that only support such S-NSSAIs/RRSGs can be in additions indicated.

In some embodiments, NG-RAN indicates the list of RRSG of the cell used by the UE.

In some embodiments, the NSSF may indicate whether the UE shall consider the list of supported RRSG as “supported” by the cell or as “served” by the cell.

In some embodiments, AMF may ensure for UE that indicates support for the RRSG functionality that S-NSSAIs provided to the UE are configured to be associated to some RRSG.

In some embodiments, the UE didn't request any specific S-NSSAI the Allowed NSSAI includes the S-NSSAI set as default S-NSSAI in the subscription which is not tied to any RRSG.

In some embodiments, the AMF may check used RRSG by comparing the list of RRSG of current cell, provided by NG-RAN, used by the UE with the list of RRSG for the S-NSSAIs in the Allowed NSSAI.

In some embodiments, the AMF may also indicate in the Access Stratum Connection Establishment NSSAI Inclusion Mode that the UE is to indicate the RRSG of the S-NSSAIs during the RRC Connection Establishment. See TS 23.501 clause 5.15.9 for current logic related to Access Stratum Connection Establishment NSSAI Inclusion Mode used to steer the UE whether to include list of NSSAI in RRC connection establishment.

In some embodiments, the UE checks the Access Stratum Connection Establishment NSSAI Inclusion Mode whether to indicate any S-NSSAI or RRSG during the RRC Connection Establishment.

In some embodiments, NG-RAN indicates the list of RRSG of the cell used by the UE to the AMF.

In some embodiments, the NSSF may indicate whether the UE shall consider the list of supported RRSG as “supported” by the cell or as “served” by the cell.

In some embodiments, the AMF may check used RRSG by comparing the list of RRSG of current cell used by the UE with the list of RRSG for the S-NSSAIs in the Allowed NSSAI. As the Allowed NSSAI includes the S-NSSAI-1 and S-NSSAI-2, and S-NSSAI-2 is associated to RRSG-B, the AMF checks whether the list of RRSG provided by the NG-RAN includes RRSG-B. If the check fails, and “supported” logic is used, the AMF may reject the UE request with an appropriate error cause, or (if “served” logic is used, the AMF may invoke procedures as if the UE didn't support the RRSG functionality e.g., let NG-RAN redirect the UE to appropriate cell by indicating Allowed NSSAI and RFSP to the NG-RAN (as AMF treats the S-NSSAIs as supported in all cells of the TAs) and in addition indicate the list of RRSG for the Allowed NSSAI to the NG-RAN. The NG-RAN will then apply RRM logic e.g., Release the RRC connection with dedicated cell reselection priorities according to cells supporting all S-NSSAIs, if possible.

In some embodiments, the N2/NGAP message to NG-RAN may also include the list of RRSG that the Allowed NSSAI are associated to i.e., in this case RRSG-B. The NG-RAN may use the information to perform RRM logic e.g., RRC release with dedicated cell reselection priorities with RRSG-B.

In some embodiments, a list of RRSG for the cell selected by the UE is provided to the AMF.

In some embodiments, extending NG SETUP information with supported RRSG e.g., per TA.

In some embodiments, support checking the list of RRSG per current cell of the UE as indicated by NG-RAN and the list of RRSG for the S-NSSAIs in the Allowed NSSAI.

In some embodiments, extending Nnssf_NSSAIAvailability service operation with supported RRSG of the NG-RAN.

In some embodiments, NSSF may indicate to AMF whether the UE shall consider the list of supported RRSG as “supported” by the cell or as “served” by the cell.

Some of the following was included in the appendices included with the priority document.

The principle of the solution is that NG-RAN broadcast on a per cell basis the network slice specific information as to steer the UE logic with regards to cell (re)selection dependent on Network Slice the UE uses.

### 6.x.2 High-Level Description

The following sequence of events are envisioned:
1. Network Slice is created supporting specific radio spectrum to support vertical requirements, and other Network Slices, e.g., eMBB, are created supporting all the radio spectrum available for the operator;
2. The NG-RAN and AMF exchange support of S-NSSAIs as per current specifications i.e., AMF indicates the S-NSSAIs the AMF supports and the NG-RAN indicates the S-NSSAIs the NG-RAN support per TA;
3. The UE has a subscription for one or more S-NSSAIs and at least one S-NSSAI has specific requirements in relation to specific cells the S-NSSAI is to be available or specific frequency band requirements S-NSSAI;
4. The S-NSSAIs requiring specific NG-RAN control are assigned Radio Resource Slice Group (RRSG) values. One or more S-NSSAIs may get the same RRSG value assigned.
5. The NG-RAN gets configured by O&M which RRSG to broadcast per cell. The cell may broadcast RRSG values in . . . a. List of supported RRSG for current cell; b. List of supported RRSG for neighbour cells; c. Cell reselection priority per RRSG
6. When the NG-RAN release the UE with RRC release message, the NG-RAN may, as per current specifications, indicate dedicated cell reselection priorities corresponding to the S-NSSAIs that the UE currently uses (Allowed NSSAI or S-NSSAIs of PDU Sessions with active UP), the NG-RAN may in addition indicate dedicated cell reselection priorities per RRSG;
a. The UE prioritizes the NG-RAN provided dedicated cell reselection priorities per RRSG over the cell reselection priority per RRSG indicated in SIB;
7. AMF and NSSF may use RRSG as input in the network slice selection for the UE e.g., if UE does not support RRSG the S-NSSAIs associated to RRSGs may be omitted from being included in the Allowed NSSAI and Configured NSSAI.
8. To allow the NG-RAN to differentiate the paging, the paging message from the 5GC to NG-RAN may include the list of RRSG (or S-NSSAIs) that the paging is related to.

The steps of are as follows:
1. The NG-RAN and the AMFs exchange the support of S-NSSAIs as per current TS 38.413;
2. The UE performs network selection as per current means (as UE is initially not configured with any slicing information).
3. The UE sends a Registration Request indicating that the UE supports RRSG functionality, but without any Requested NSSAI as the UE has no slicing configuration for the PLMN;
4. The NG-RAN forwards the NAS message to the selected AMF.
5. The AMF and, if supported, the NSSF performs Network Slice selection. AMF sends the Nssf_NSSelection request to the NSSF. Optionally the request indicates that RRSG is supported i.e., both the UE and the AMF supports NSSG (the information can be provided as a parameter in the Nssf_NSSelection service operation message payload or using the feature negotiation mechanism specified in clause 6.6 of 3GPP TS 29.500);
6. The NSSF response includes Allowed NSSAI and Configured NSSAI as per current specifications but may also include one or more RRSG per S-NSSAI as per the configuration of the S-NSSAIs in the NSSF (derived at O&M phase and per SLA in case of roaming) i.e., for the S-NSSAI that are configured with any RRSG. If the AMF did not indicate support for RRSG, then NSSF may omit providing S-NSSAIs associated with RRSG.
7. The AMF may ensure for UE that did not indicates support for the RRSG functionality that S-NSSAIs provided to the UE are not configured to be associated to some RRSG.

As the UE has not yet been configured with any network slice information, the UE didn't request any specific S-NSSAI the Allowed NSSAI includes the S-NSSAI set as default S-NSSAI in the subscription which is not tied to any RRSG.
8. The AMF sends the Registration Accept to the UE via NG-RAN as per current procedures and includes the list of RRSG per S-NSSAI (in the example only the S-NSSAI-2 of the Configured NSSAI of the serving network e.g., PLMN is associated to an RRSG-B).

The UE stores the received information;
9. The UE decides, after a while, to register S-NSSAI-2 (e.g., an application associated to the S-NSSAI-2 initiates a communication).
10. S-NSSAI-2 is associated to RRSG-B and therefore the UE, that is in RRC Idle or RRC Inactive, performs a cell re-selection according to RRSG-B e.g., according to the cell reselection priorities for RRSG-B or to a cell supporting RRSG-B.
11. When the UE has selected a cell that supports the RRSG of S-NSSAI-2, the UE sends a Registration Request indicating that the UE supports RRSG functionality and a Requested NSSAI with S-NSSAI-1 and S-NSSAI-2.
12. The NG-RAN forwards the NAS message to the selected AMF.
13. The AMF and, if supported, the NSSF performs Network Slice selection. AMF sends the Nssf_NSSelection request to the NSSF. Optionally the request indicates that RRSG is supported i.e., both the UE and the AMF supports NSSG (the information can be provided as a parameter in the Nssf_NSSelection service operation message payload or using the feature negotiation mechanism specified in clause 6.6 of 3GPP TS 29.500);
14. The NSSF response includes Allowed NSSAI and Configured NSSAI as per current specifications but may also include one or more RRSG per S-NSSAI i.e., for the S-NSSAI that are configured with any RRSG.
15. The AMF may check the RRSG, i.e., if S-NSSAIs provided to the UE are configured to be associated to some RRSG then the UE is required to support the RRSG functionality.
16. The AMF sends the Registration Accept to the UE via NG-RAN as per current procedures and includes in the NAS Registration Accept the list of RRSG per S-NSSAI (in the example the S-NSSAI-2 of the Allowed NSSAI (and Configured NSSAI) is associated to an RRSG-B);

The UE stores the information and applies the applicable logic e.g., the UE includes the RRSG in cell re-selection logic, UE does not request to activate User Plane for an S-NSSAI for which the RRSG is not supported by the cell the UE uses.
A. At a later point the 5GC/AMF performs the Network Triggered Service Request procedure as per TS 23.502 clause 4.2.3.3. The AMF includes a list of RRSG (or S-NSSAI) for the S-NSSAI(s) related to the service(s) the UE Network Triggered Service Request procedure is for. The AMF includes the RRSG only for UE's that support RRSG (i.e., the AMF stored the information that the UE supports RRSG in the UE context information in the AMF, see clause 5.2.2.2.2 of TS 23.502).

The NG-RAN uses the list of RRSG (or S-NSSAI) in the paging logic e.g., priority cells or performs paging only in cells supporting the RRSGs.

### 6.x.4 Impacts on Services, Entities and Interfaces

The impacts to the 5GS entities are the following:
UE: —Indicates support for RRSG to AMF; —Performs cell reselection taking into account list of RRSG for S-NSSAIs the UE has registered and for the S-NSSAI that the UE request to be registered;
NG-RAN: —Provides RRSG information in SIB; —Takes into account list of RRSG at paging;
AMF: —Support RRSG functionality by indicating support to NSSG, and support receiving RRSG information from the NSSF; —Support extending the slicing information to the UE with list of RRSG per S-NSSAI; —Support indicating list of RRSG to NG-RAN at paging;
NSSF: —Takes into account RRSG at network slice selection e.g., does not provide an S-NSSAI in Allowed NSSAI in case the AMF does not indicate support of the RRSG functionality, and when RRSG is supported provides RRSG information associated to S-NSSAI configured with it.

The existing capabilities of the 5GS, e.g., the ability to steer UEs to certain frequencies based on RFSP, Allowed NSSAI and activated UP, together with a suitable resource partitioning of the NG-RAN resources, enable the 5GS to support the case where the network operator prefers that certain network slices use certain frequencies (certain network slices may get dedicated resources by NG-RAN resource partitioning in preferred frequencies).

Existing capabilities of the 5GS do not fully support the case where certain frequencies cannot be used to access a slice, in particular as described in clause 5.7 “how to select a particular cell that can be used to access the network slice(s) when the operator manages a different range of radio spectrums per network slice”.
Existing (Rel-15/16) 5GS behaviour is that when the UE attempts to simultaneously register with slices that are not available in a common operating band, it is assumed that some requested slices will be not allowed based on the network policies. The UE then can retry with a different Requested NSSAI if the current Allowed NSSAI is not suitable for its needs. This can result in several trials and errors till a stable state between UE and network is achieved. Or, if the S-NSSAI not allowed is provided as a Rejected S-NSSAI for the RA, the UE may wait to request the S-NSSAI until the UE moves out of the RA.

The following interim conclusions are agreed:
Serving specific S-NSSAI(s) per individual cells of a TA (e.g., if certain frequencies cannot be used to access a network slice or there is a wish to create an area for a specific set of network slices consisting of one or more cells within a TA) is achieved as follows:
From a 5GC perspective all cells of a tracking area support the same S-NSSAI(s) and the S-NSSAI(s) of the Allowed NSSAI are supported by all tracking areas in a registration area;
NG-RAN and the UE may support the availability of cells within a TA that does not support all the S-NSSAIs that NG-RAN indicated as supported to the AMF during NGAP SETUP. This is achieved by associating an S-NSSAI with one or more Radio Resource Slice Group (RRSG) and the NG-RAN broadcast to optionally include List of supported RRSG for current cell, List of supported RRSG for neighbour cells, and Cell reselection priority per RRSG.
The AMF and the NNSF may optionally assist the RRSG functionality by providing the UE with a list of RRSG an S-NSSAI is associated to e.g., in Allowed NSSAI and Configured NSSAI. Further, the AMF may provide a list of RRSG to NG-RAN at paging;
The UE may optionally support the RRSG functionality and take RRSG information into account at cell re-selection and not requesting to register an S-NSSAI or activate UP of an S-NSSAI when the RRSG associated to the S-NSSAI is not supported by the current cell.

SA2 discussed the RAN2 agreements as available in the RAN2 chairman notes:

### Agreements

1 For cell reselection scenario, RAN2 to agree the following:

To assist cell reselection, RAN can broadcast the supported slice info of the current cell and neighbour cells, and cell reselection priority per slice. The slice info may be: providing only SST, on-demand SIB, SIB segmentation, slice grouping (if any), or slice associated UAC information where other solutions are not precluded. Details can be discussed in WI phase.

2 Agree on adding the slice info (with similar information as agreed slice info in SI message) in RRC release message. Details can be discussed in WI phase.

3 Not pursue the solution of adding the intended slice for MT access in slice specific cell (re)selection.

4 The following solutions are recommended for normative work: —To assist cell reselection, RAN can broadcast the supported slice info of the current cell and neighbour cells, and cell reselection priority per slice;—adding the slice info (with similar information as agreed slice info in SI message) in RRC release message.

How to ensure UE doesn't lose coverage due to slice prioritization can be considered in WI phase.

1 For cell selection scenario, RAN2 may discuss during WI whether to broadcast supported slice of serving cell in S1 message and how to solve SIB1 concerns. SA2 have the following question: 1. What is the intended UE logic and the intended network logic in relation to cells indicating “supported slice info of the current cell and neighbour cells”?

Providing S-NSSAI in SIB has been discussed before and it was agreed that the S-NSSAI is not suitable for broadcast due its:—Size, and—privacy

Therefore, if RAN2 progresses with providing slicing information in SIB, then S-NSSAI is not suitable, and alternatives should be considered. Alternatives has been discussed in RAN2 as:

“The concerns on security and SIB payload size for broadcasting slice related cell selection info need to be resolved in WI phase(e.g., providing only SST, on-demand SIB, SIB segmentation, slice grouping or slice associated UAC information).”

Using only the SST would not be enough as it would not give the possibility to differentiate different requirements for network slices, and to some extent the privacy issue may still remain. SIB segmentation could be possible from a size perspective but does not solve the privacy aspect. Slice association to UAC information could be possible, but the slice information in UAC is limited in size and the UAC grouping is for a different purpose i.e., a grouping to handle congestion situations rather than per frequency or per area consideration. What is left is the “slice grouping”

OBSERVATION 1: The S-NSSAI is not suitable to be provided in SIB.

PROPOSAL 1: If network slice information is to be provided in SIB, then some “slice grouping” is preferred.

The slice grouping is in this context an issue for RAN2 scope from an RRM perspective and not used within the 5GC and therefore the groups can be tied to the RRM e.g., the slice groups can be called Radio Resource Slice Group (RRSG). As NG-RAN gets configured by OAM the RRSG is configured in NG-RAN by OAM.

[Internal: OAM configuration may be result of SLA and service prioritization per slice requirements.]

PROPOSAL 2: Define the slice groups as Radio Resource Slice Group (RRSG).

As the S-NSSAI association to RRSG would be network specific (PLMN or SNPN) the information cannot be assumed to be known by the UE before the UE registers the first time to the network. Therefore, the UE would need to be provided with the S-NSSAI to RRSG association upon the registration to the network and possibly by updated with the information at subsequent registration in the same way as the UE is updated with new Configured NSSAI and Allowed NSSAI.

PROPOSAL 3: The UE is provided with the S-NSSAI and RRSG association at Registration procedures.

The SIB information listed by RAN2 was (replacing “slice info” with RRSG): a. List of supported RRSG for current cell; b. List of supported RRSG for neighbour cells; c. Cell reselection priority per RRSG

The cell reselection priorities seem transparent to 5GC and makes it possible for the UE to apply prioritized cell res-selection based on S-NSSAIs in Allowed NSSAI and S-NSSAIs that the UE intends to register in Requested NSSAI.

However, list of supported RRSG would imply that the cells of the TA include non-homogeneous support of S-NSSAIs.

Propagating a per cell level information of network slices to 5GC would considerably increase the complexity and require further study unless the 5GC can handle the support of network slices as homogenously supported in all cells of the TA with some minor additional logic.

PROPOSAL 4: The existing 5GC logic of assuming all cells of a TA supports the same S-NSSAIs is kept.

NOTE: Proposal 4 implies that the TAI list of the RA and the associated Allowed NSSAI can be assigned as per current specifications e.g., assigning RA considering the mobility of the UE.

The usage of “supported” in the RAN2 agreement “RAN can broadcast the supported slice info of the current cell and neighbour cells” is not clear. Following interpretations are possible:

1. SIB lists the network slices (e.g., the RRSG) that the cell is defined to handle Other network slices will not be allowed to be “registered” when the UE camps or uses the cell.

2. SIB lists the network slices (e.g., the RRSG) that the cell is defined to serve with Radio Resources dedicated for the slice. The network may choose to use CA/DC to serve the UE with Radio Resources dedicated for the slice. Any slice can be “registered” i.e., in the Allowed NSSAI but no functionality requiring radio resources specifically for the slices not part of the “supported slices” are allowed. Activation of User Plane for a PDU Session is not allowed in such cases. UE needs to perform cell reselection to select suitable cell supporting the S-NSSAI's associated RRSG;

3. Support with lower QoS?? . . . ?

The usage of “supported” in the RAN2 agreement “RAN can broadcast the supported slice info of the current cell and neighbour cells” is not clear from a UE logic perspective. Following interpretations are possible:

UE can try to register or establish a PDU Session and activate UP for an S-NSSAI associated to an RRSG not listed in SIB as supported by the cell, while UE is not in the coverage of other cell/frequency that supports such RRSG

UE can rely upon network logic to steer the UE to another cell or to enable e.g., CA, DC, or support access to the slice with limited Qos

UE cannot try to register or establish a PDU Session and activate UP for an S-NSSAI associated to an RRSG not listed in SIB as supported by the cell

Unless UE can re-select to other cell with S-NSSAI associated to an RRSG listed in SIB, UE cannot get access to the network slice.

PROPOSAL 5: Send an LS to RAN2 asking for clarification of the intended UE and network logic for cells indicating “supported slice info of the current cell and neighbour cells”.
“Code points in SIB in cell” to indicate UE behaviour per slice “type”
Slices grouped in RRSG listed in SIB in this cell (code points per listed RRSG)
0—Access to slice in RRSG not provided in this cell
1—Access to slice in RRSG provided via this cell, but UE should only access the slice via this cell if no other cell/freq provides coverage for UE
2—Access to slice in RRSG is not restricted in this cell
Slices groped in RRSG for UE but not listed in SIB in this cell (UE behaviour common for all slices in this slice type, code points common for all slices in this slice type)
Access to slice (not in RRSG in SIB) not provided in this cell
Access to slice in RRSG provided via this cell, but UE should only access the slice via this cell if no other cell/freq provides coverage for UE
Slices not grouped in RRSG for UE (UE behaviour common for all slices in this slice type, code points common for all slices in this slice type)
Access to slice (not in RRSG for UE) not provided in this cell
Access to slice (not in RRSG for UE) provided via this cell, but UE should only access the slice via this cell if no other cell/freq provides coverage for UE
Access to slice in RRSG is not restricted in this cell.

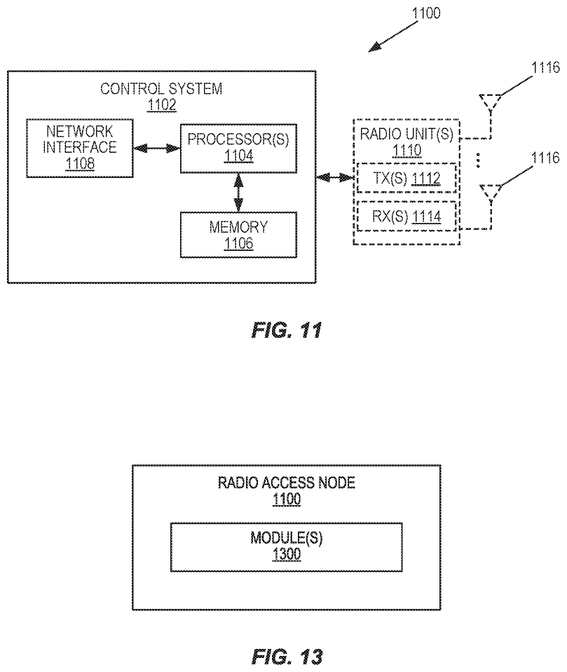

FIG. 11 is a schematic block diagram of a radio access node 1100 according to some embodiments of the present disclosure. Optional features are represented by dashed boxes. The radio access node 1100 may be, for example, a base station 302 or 306 or a network node that implements all or part of the functionality of the base station 302 or gNB described herein. As illustrated, the radio access node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the radio access node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of a radio access node 1100 as described herein. In some embodiments, the function(s) are implemented in software that is stored, e.g., in the memory 1106 and executed by the one or more processors 1104.

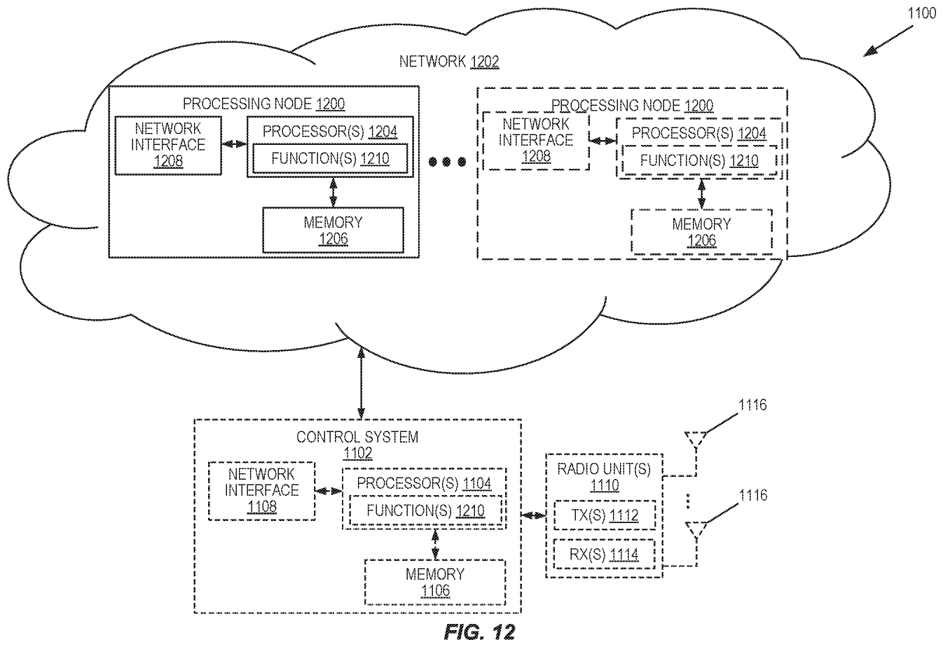

FIG. 12 is a schematic block diagram that illustrates a virtualized embodiment of the radio access node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1100 in which at least a portion of the functionality of the radio access node 1100 is implemented as a virtual component(s) (e.g., via a virtual machine(s) executing on a physical processing node(s) in a network(s)). As illustrated, in this example, the radio access node 1100 may include the control system 1102 and/or the one or more radio units 1110, as described above. The control system 1102 may be connected to the radio unit(s) 1110 via, for example, an optical cable or the like. The radio access node 1100 includes one or more processing nodes 1200 coupled to or included as part of a network(s) 1202. If present, the control system 1102 or the radio unit(s) are connected to the processing node(s) 1200 via the network 1202. Each processing node 1200 includes one or more processors 1204 (e.g., CPUs, ASICs, FPGAS, and/or the like), memory 1206, and a network interface 1208.

In this example, functions 1210 of the radio access node 1100 described herein are implemented at the one or more processing nodes 1200 or distributed across the one or more processing nodes 1200 and the control system 1102 and/or the radio unit(s) 1110 in any desired manner. In some particular embodiments, some or all of the functions 1210 of the radio access node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of radio access node 1100 or a node (e.g., a processing node 1200) implementing one or more of the functions 1210 of the radio access node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the radio access node 1100 according to some other embodiments of the present disclosure. The radio access node 1100 includes one or more modules 1300, each of which is implemented in software. The module(s) 1300 provide the functionality of the radio access node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

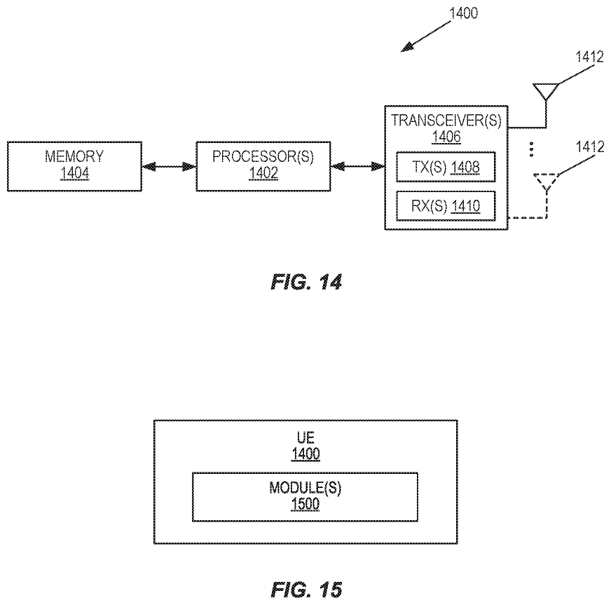

FIG. 14 is a schematic block diagram of a wireless communication device 1400 according to some embodiments of the present disclosure. As illustrated, the wireless communication device 1400 includes one or more processors 1402 (e.g., CPUs, ASICS, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein.

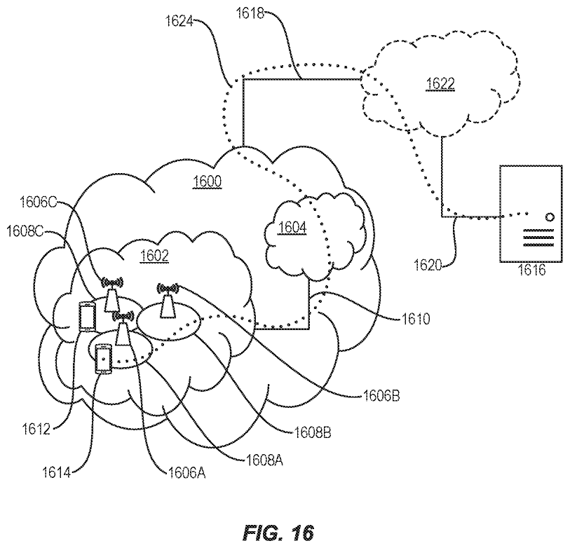

With reference to FIG. 16, in accordance with an embodiment, a communication system includes a telecommunication network 1600, such as a 3GPP-type cellular network, which comprises an access network 1602, such as a RAN, and a core network 1604. The access network 1602 comprises a plurality of base stations 1606A, 1606B, 1606C, such as Node Bs, eNBs, gNBs, or other types of wireless Access Points (APs), each defining a corresponding coverage area 1608A, 1608B, 1608C. Each base station 1606A, 1606B, 1606C is connectable to the core network 1604 over a wired or wireless connection 1610. A first UE 1612 located in coverage area 1608C is configured to wirelessly connect to, or be paged by, the corresponding base station 1606C. A second UE 1614 in coverage area 1608A is wirelessly connectable to the corresponding base station 1606A. While a plurality of UEs 1612, 1614 are illustrated in this example, the disclosed embodiments are equally applicable to a situation where a sole UE is in the coverage area or where a sole UE is connecting to the corresponding base station 1606.

The telecommunication network 1600 is itself connected to a host computer 1616, which may be embodied in the hardware and/or software of a standalone server, a cloud-implemented server, a distributed server, or as processing resources in a server farm. The host computer 1616 may be under the ownership or control of a service provider, or may be operated by the service provider or on behalf of the service provider. Connections 1618 and 1620 between the telecommunication network 1600 and the host computer 1616 may extend directly from the core network 1604 to the host computer 1616 or may go via an optional intermediate network 1622. The intermediate network 1622 may be one of, or a combination of more than one of, a public, private, or hosted network; the intermediate network 1622, if any, may be a backbone network or the Internet; in particular, the intermediate network 1622 may comprise two or more sub-networks (not shown).

The communication system of FIG. 16 as a whole enables connectivity between the connected UEs 1612, 1614 and the host computer 1616. The connectivity may be described as an Over-the-Top (OTT) connection 1624. The host computer 1616 and the connected UEs 1612, 1614 are configured to communicate data and/or signaling via the OTT connection 1624, using the access network 1602, the core network 1604, any intermediate network 1622, and possible further infrastructure (not shown) as intermediaries. The OTT connection 1624 may be transparent in the sense that the participating communication devices through which the OTT connection 1624 passes are unaware of routing of uplink and downlink communications. For example, the base station 1606 may not or need not be informed about the past routing of an incoming downlink communication with data originating from the host computer 1616 to be forwarded (e.g., handed over) to a connected UE 1612. Similarly, the base station 1606 need not be aware of the future routing of an outgoing uplink communication originating from the UE 1612 towards the host computer 1616.

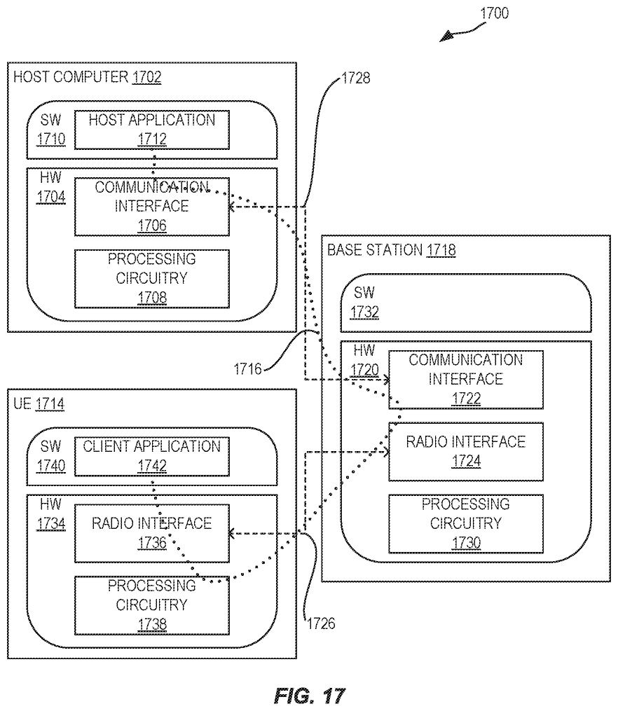

Example implementations, in accordance with an embodiment, of the UE, base station, and host computer discussed in the preceding paragraphs will now be described with reference to FIG. 17. In a communication system 1700, a host computer 1702 comprises hardware 1704 including a communication interface 1706 configured to set up and maintain a wired or wireless connection with an interface of a different communication device of the communication system 1700. The host computer 1702 further comprises processing circuitry 1708, which may have storage and/or processing capabilities. In particular, the processing circuitry 1708 may comprise one or more programmable processors, ASICs, FPGAs, or combinations of these (not shown) adapted to execute instructions. The host computer 1702 further comprises software 1710, which is stored in or accessible by the host computer 1702 and executable by the processing circuitry 1708. The software 1710 includes a host application 1712. The host application 1712 may be operable to provide a service to a remote user, such as a UE 1714 connecting via an OTT connection 1716 terminating at the UE 1714 and the host computer 1702. In providing the service to the remote user, the host application 1712 may provide user data which is transmitted using the OTT connection 1716.

The communication system 1700 further includes a base station 1718 provided in a telecommunication system and comprising hardware 1720 enabling it to communicate with the host computer 1702 and with the UE 1714. The hardware 1720 may include a communication interface 1722 for setting up and maintaining a wired or wireless connection with an interface of a different communication device of the communication system 1700, as well as a radio interface 1724 for setting up and maintaining at least a wireless connection 1726 with the UE 1714 located in a coverage area (not shown in FIG. 17) served by the base station 1718. The communication interface 1722 may be configured to facilitate a connection 1728 to the host computer 1702. The connection 1728 may be direct or it may pass through a core network (not shown in FIG. 17) of the telecommunication system and/or through one or more intermediate networks outside the telecommunication system. In the embodiment shown, the hardware 1720 of the base station 1718 further includes processing circuitry 1730, which may comprise one or more programmable processors, ASICS, FPGAS, or combinations of these (not shown) adapted to execute instructions. The base station 1718 further has software 1732 stored internally or accessible via an external connection.

The communication system 1700 further includes the UE 1714 already referred to. The UE's 1714 hardware 1734 may include a radio interface 1736 configured to set up and maintain a wireless connection 1726 with a base station serving a coverage area in which the UE 1714 is currently located. The hardware 1734 of the UE 1714 further includes processing circuitry 1738, which may comprise one or more programmable processors, ASICs, FPGAs, or combinations of these (not shown) adapted to execute instructions. The UE 1714 further comprises software 1740, which is stored in or accessible by the UE 1714 and executable by the processing circuitry 1738. The software 1740 includes a client application 1742. The client application 1742 may be operable to provide a service to a human or non-human user via the UE 1714, with the support of the host computer 1702. In the host computer 1702, the executing host application 1712 may communicate with the executing client application 1742 via the OTT connection 1716 terminating at the UE 1714 and the host computer 1702. In providing the service to the user, the client application 1742 may receive request data from the host application 1712 and provide user data in response to the request data. The OTT connection 1716 may transfer both the request data and the user data. The client application 1742 may interact with the user to generate the user data that it provides.

It is noted that the host computer 1702, the base station 1718, and the UE 1714 illustrated in FIG. 17 may be similar or identical to the host computer 1616, one of the base stations 1606A, 1606B, 1606C, and one of the UEs 1612, 1614 of FIG. 16, respectively. This is to say, the inner workings of these entities may be as shown in FIG. 17 and independently, the surrounding network topology may be that of FIG. 16.

In FIG. 17, the OTT connection 1716 has been drawn abstractly to illustrate the communication between the host computer 1702 and the UE 1714 via the base station 1718 without explicit reference to any intermediary devices and the precise routing of messages via these devices. The network infrastructure may determine the routing, which may be configured to hide from the UE 1714 or from the service provider operating the host computer 1702, or both. While the OTT connection 1716 is active, the network infrastructure may further take decisions by which it dynamically changes the routing (e.g., on the basis of load balancing consideration or reconfiguration of the network).

The wireless connection 1726 between the UE 1714 and the base station 1718 is in accordance with the teachings of the embodiments described throughout this disclosure. One or more of the various embodiments improve the performance of OTT services provided to the UE 1714 using the OTT connection 1716, in which the wireless connection 1726 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1716 between the host computer 1702 and the UE 1714, in response to variations in the measurement results. The measurement procedure and/or the network functionality for reconfiguring the OTT connection 1716 may be implemented in the software 1710 and the hardware 1704 of the host computer 1702 or in the software 1740 and the hardware 1734 of the UE 1714, or both. In some embodiments, sensors (not shown) may be deployed in or in association with communication devices through which the OTT connection 1716 passes; the sensors may participate in the measurement procedure by supplying values of the monitored quantities exemplified above, or supplying values of other physical quantities from which the software 1710, 1740 may compute or estimate the monitored quantities. The reconfiguring of the OTT connection 1716 may include message format, retransmission settings, preferred routing, etc.; the reconfiguring need not affect the base station 1718, and it may be unknown or imperceptible to the base station 1718. Such procedures and functionalities may be known and practiced in the art. In certain embodiments, measurements may involve proprietary UE signaling facilitating the host computer 1702's measurements of throughput, propagation times, latency, and the like. The measurements may be implemented in that the software 1710 and 1740 causes messages to be transmitted, in particular empty or ‘dummy’ messages, using the OTT connection 1716 while it monitors propagation times, errors, etc.

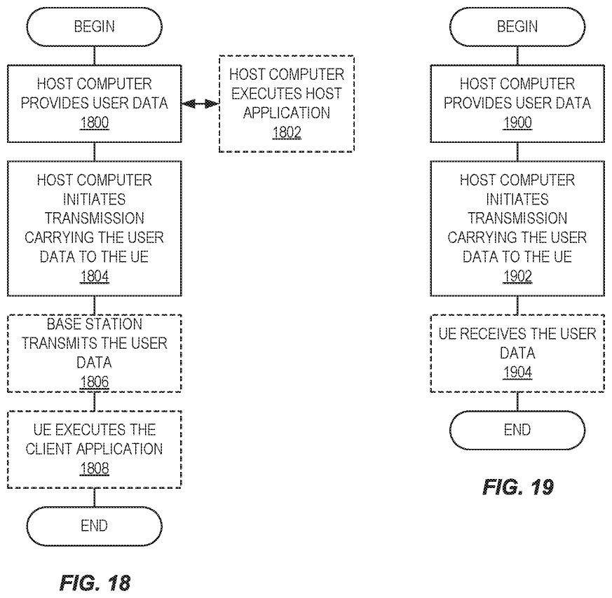

FIG. 18 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 18 will be included in this section. In step 1800, the host computer provides user data. In sub-step 1802 (which may be optional) of step 1800, the host computer provides the user data by executing a host application. In step 1804, the host computer initiates a transmission carrying the user data to the UE. In step 1806 (which may be optional), the base station transmits to the UE the user data which was carried in the transmission that the host computer initiated, in accordance with the teachings of the embodiments described throughout this disclosure. In step 1808 (which may also be optional), the UE executes a client application associated with the host application executed by the host computer.

FIG. 19 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 19 will be included in this section. In step 1900 of the method, the host computer provides user data. In an optional sub-step (not shown) the host computer provides the user data by executing a host application. In step 1902, the host computer initiates a transmission carrying the user data to the UE. The transmission may pass via the base station, in accordance with the teachings of the embodiments described throughout this disclosure. In step 1904 (which may be optional), the UE receives the user data carried in the transmission.

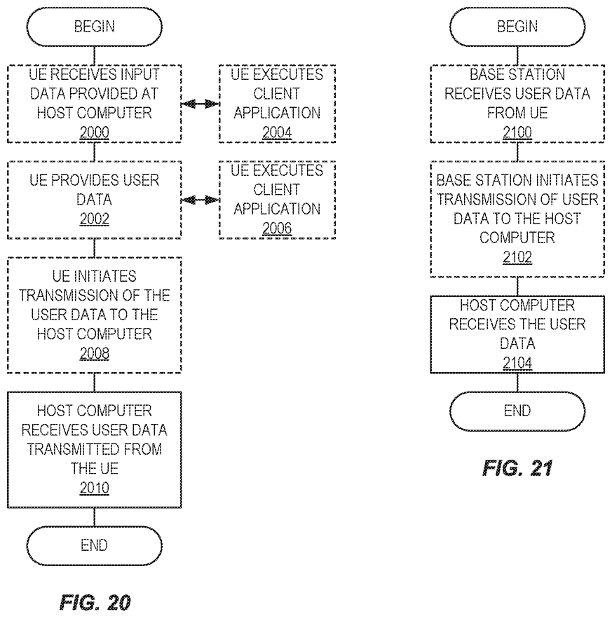

FIG. 20 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 20 will be included in this section. In step 2000 (which may be optional), the UE receives input data provided by the host computer. Additionally or alternatively, in step 2002, the UE provides user data. In sub-step 2004 (which may be optional) of step 2000, the UE provides the user data by executing a client application. In sub-step 2006 (which may be optional) of step 2002, the UE executes a client application which provides the user data in reaction to the received input data provided by the host computer. In providing the user data, the executed client application may further consider user input received from the user. Regardless of the specific manner in which the user data was provided, the UE initiates, in sub-step 2008 (which may be optional), transmission of the user data to the host computer. In step 2010 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 21 will be included in this section. In step 2100 (which may be optional), in accordance with the teachings of the embodiments described throughout this disclosure, the base station receives user data from the UE. In step 2102 (which may be optional), the base station initiates transmission of the received user data to the host computer. In step 2104 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group A Embodiments

Embodiment 1: A method performed by a wireless device for inhomogeneous slice support, the method comprising one or more of: receiving (600), from one or more cells, an indication of which slices are supported by the cell; and receiving (602) an information on how the wireless device may act based on the indicated slice support.

Embodiment 2: A method performed by a wireless device for inhomogeneous slice support, the method comprising one or more of: signaling (700), to a Core Network, CN, an indication that the wireless device supports non-uniform slice availability.

Embodiment 3: The method of any of the previous embodiments wherein signaling the indication is upon performing Non-Access Stratum, NAS, registration.

Embodiment 4: The method of any of the previous embodiments wherein signaling the indication is performed using one or more of: a. as part of NAS signaling from the wireless device to CN, and transparently to the RAN; and b. as part of AS signaling, from wireless device to RAN and then forwarded from RAN to CN via the common RAN-CN interface.

Embodiment 5: The method of any of the previous embodiments wherein the AS signaling comprises signaling via RRC signaling.

Embodiment 6: The method of any of the previous embodiments wherein the common RAN-CN interface comprises the NG interface.

Embodiment 7: The method of any of the previous embodiments wherein the indication comprises one or more of: a. a capability of the wireless device to support broadcast information on slices or group of slices served by a specific cell or radio coverage layer or frequency layer; b. a capability of the wireless device to support non uniform slice availability and by that of not requesting access to slices or services on the slice in those areas within the RA, where the slice is not available.

Embodiment 8: The method of any of the previous embodiments further comprising: requesting access to the slices in the Allowed NSSAI whenever they are available at the RAN node or cell serving the wireless device.

Embodiment 9: The method of any of the previous embodiments wherein the area comprises a single cell.

Embodiment 10: The method of any of the previous embodiments wherein a network slice identified by an S-NSSAI.

Embodiment 11: The method of any of the previous embodiments, further comprising: providing user data; and forwarding the user data to a host computer via the transmission to the base station.

### Group B Embodiments

Embodiment 12: A method performed by a base station or network node for inhomogeneous slice support, the method comprising one or more of: receiving (800) an indication of whether a wireless device supports non-uniform slice availability; assigning (802) an appropriate Allowed NSSAI to the wireless device; if the wireless device supports non uniform slice availability, including (804) in the Allowed NSSAI slices that are not uniformly available within the RA; if the wireless device does not support non uniform slice availability, including (806) in the Allowed NSSAI only slices that are uniformly available within the RA; controlling (808) the wireless device to provide a reference to a group of Slices (RRSG) at RRC Connection establishment; and verifying (810) that the wireless device used correct RRSG.

Embodiment 13: The method of any of the previous embodiments further comprising: receiving such an indication and forwarding the indication to the CN serving the wireless device by means of RAN-CN signaling.

Embodiment 14: The method of any of the previous embodiments wherein the AS signaling comprises signaling via RRC signaling.

Embodiment 15: The method of any of the previous embodiments wherein the common RAN-CN interface comprises the NG interface.

Embodiment 16: The method of any of the previous embodiments wherein the indication comprises one or more of: a. a capability of the wireless device to support broadcast information on slices or group of slices served by a specific cell or radio coverage layer or frequency layer; b. a capability of the wireless device to support non uniform slice availability and by that of not requesting access to slices or services on the slice in those areas within the RA, where the slice is not available.

Embodiment 17: The method of any of the previous embodiments further comprising: requesting access to the slices in the Allowed NSSAI whenever they are available at the RAN node or cell serving the wireless device.

Embodiment 18: The method of any of the previous embodiments wherein the area comprises a single cell.

Embodiment 19: The method of any of the previous embodiments wherein a network slice identified by an S-NSSAI.

Embodiment 20: The method of any of the previous embodiments, further comprising: obtaining user data; and forwarding the user data to a host computer or a wireless device.

### Group C Embodiments

Embodiment 21: A wireless device for inhomogeneous slice support, the wireless device comprising: processing circuitry configured to perform any of the steps of any of the Group A embodiments; and power supply circuitry configured to supply power to the wireless device.

Embodiment 22: A base station for inhomogeneous slice support, the base station comprising: processing circuitry configured to perform any of the steps of any of the Group B embodiments; and power supply circuitry configured to supply power to the base station.

Embodiment 23: A User Equipment, UE, for inhomogeneous slice support CN, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 24: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 25: The communication system of the previous embodiment further including the base station.

Embodiment 26: The communication system of the previous 2 embodiments, further including the UE, wherein the UE is configured to communicate with the base station.

Embodiment 27: The communication system of the previous 3 embodiments, wherein: the processing circuitry of the host computer is configured to execute a host application, thereby providing the user data; and the UE comprises processing circuitry configured to execute a client application associated with the host application.

Embodiment 28: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 29: The method of the previous embodiment, further comprising, at the base station, transmitting the user data.

Embodiment 30: The method of the previous 2 embodiments, wherein the user data is provided at the host computer by executing a host application, the method further comprising, at the UE, executing a client application associated with the host application.

Embodiment 31: A User Equipment, UE, configured to communicate with a base station, the UE comprising a radio interface and processing circuitry configured to perform the method of the previous 3 embodiments.

Embodiment 32: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 33: The communication system of the previous embodiment, wherein the cellular network further includes a base station configured to communicate with the UE.

Embodiment 34: The communication system of the previous 2 embodiments, wherein: the processing circuitry of the host computer is configured to execute a host application, thereby providing the user data; and the UE's processing circuitry is configured to execute a client application associated with the host application.

Embodiment 35: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 36: The method of the previous embodiment, further comprising at the UE, receiving the user data from the base station.

Embodiment 37: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 38: The communication system of the previous embodiment, further including the UE.

Embodiment 39: The communication system of the previous 2 embodiments, further including the base station, wherein the base station comprises a radio interface configured to communicate with the UE and a communication interface configured to forward to the host computer the user data carried by a transmission from the UE to the base station.

Embodiment 40: The communication system of the previous 3 embodiments, wherein: the processing circuitry of the host computer is configured to execute a host application; and the UE's processing circuitry is configured to execute a client application associated with the host application, thereby providing the user data.

Embodiment 41: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 42: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 43: The method of the previous embodiment, further comprising, at the UE, providing the user data to the base station.

Embodiment 44: The method of the previous 2 embodiments, further comprising: at the UE, executing a client application, thereby providing the user data to be transmitted; and at the host computer, executing a host application associated with the client application.

Embodiment 45: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 46: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 47: The communication system of the previous embodiment further including the base station.

Embodiment 48: The communication system of the previous 2 embodiments, further including the UE, wherein the UE is configured to communicate with the base station.

Embodiment 49: The communication system of the previous 3 embodiments, wherein: the processing circuitry of the host computer is configured to execute a host application; and the UE is configured to execute a client application associated with the host application, thereby providing the user data to be received by the host computer.

Embodiment 50: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 51: The method of the previous embodiment, further comprising at the base station, receiving the user data from the UE.

Embodiment 52: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
AS Access Stratum
ASIC Application Specific Integrated Circuit
AUSF Authentication Server Function
CCNF Common Control Network Function
CN Core Network
CPU Central Processing Unit
DCI Downlink Channel Information
DN Data Network
DRB Data Radio Bearer
DSP Digital Signal Processor
eMBB Enhanced Mobile Broadband
eNB Enhanced or Evolved Node B
EPC Evolved Packet Core
EPS Evolved Packet System
E-UTRA Evolved Universal Terrestrial Radio Access
E-UTRA Evolved Universal Terrestrial Radio Access Network
FPGA Field Programmable Gate Array
gNB New Radio Base Station
gNB-CU New Radio Base Station Central Unit
gNB-DU New Radio Base Station Distributed Unit
GTP-U General Packet Radio System Tunnelling Protocol User Plane
HSS Home Subscriber Server
IOT Internet of Things
IP Internet Protocol
LTE Long Term Evolution
MAC Medium Access Control
MME Mobility Management Entity
MT Mobile Termination
MTC Machine Type Communication
NAS Non-Access Stratum
NEF Network Exposure Function
NF Network Function
NG Next Generation
NR New Radio
NRF Network Function Repository Function
NSSAI Network Slice Selection Assistance Information
NSSF Network Slice Selection Function
O&M Operation and Maintenance
OAM Operations, Administration and Maintenance
OTT Over-the-Top
PC Personal Computer
PCF Policy Control Function
PDSCH Physical Downlink Shared Channel
PDU Packet Data Unit
P-GW Packet Data Network Gateway
PLMN Public Land Mobile Network
QoS Quality of Service
RA Registration Area
RAM Random Access Memory
RAN Radio Access Network
RAN-CN Radio Access Network Core Network
RNL Radio Network Layer
ROM Read Only Memory
RRC Radio Resource Control
RRH Remote Radio Head
RRSG Radio Resource Slice Group
RTT Round Trip Time
S-NSSAI Single Network Slice Selection Assistance Information
SA System Architecture
SCEF Service Capability Exposure Function
SIB System Information Block
SLA Service Level Agreement
SMF Session Management Function
SST Slice/Service Type
TA Tracking Area
TCI Transmission Configuration Indicator
TDD Time Division Duplexing
TNL Transport Network Layer
TRP Transmission/Reception Point
UAC Unified Access Control
UDM Unified Data Management
UE User Equipment
UPF User Plane Function
WI Work Item

Those skilled in the art will recognize improvements and modifications to the embodiments of the present disclosure. All such improvements and modifications are considered within the scope of the concepts disclosed herein.

1. A method performed by a wireless device for inhomogeneous slice support, the method comprising:
signaling, to a Core Network, CN, node, an indication that the wireless device supports non-uniform slice availability; and
receiving information on how the wireless device may act based on the indicated slice support.

2. The method of claim 1 further comprising:
receiving, from one or more cells, an indication of which slices are supported.

3. The method of claim 2 further comprising:
sending a Radio Resource Control, RRC, Setup request based on the received indication of which slices are supported.

4. The method of claim 2 further comprising:
determining a cell to connect to by omitting cells that do not support a desired slice.

5. The method of claim 1 wherein signaling the indication is upon performing Non-Access Stratum, NAS, registration.

6. The method of claim 1 wherein signaling the indication is performed using one or more of:
as part of NAS signaling from the wireless device to the CN node, and transparently to a Radio Access Network, RAN; and
as part of Access Stratum, AS, signaling, from wireless device to the RAN, and then forwarded from RAN to the CN node via a common RAN-CN interface.

7. The method of claim 1 wherein the AS signaling comprises signaling via RRC signaling.

8. The method of claim 1 wherein the common RAN-CN interface comprises a Next Generation, NG, interface.

9. The method of claim 1 wherein the indication comprises one or more of:
a capability of the wireless device to support broadcast information on slices or a group of slices served by a specific cell or radio coverage layer or frequency layer; and
a capability of the wireless device to support non uniform slice availability by not requesting access to the slices or services on the slice in those areas within the Registration Area, RA, where the slice is not available.

10. The method of claim 1 further comprising:
requesting access to the slices in Allowed Network Slice Selection Assistance Information, NSSAI, whenever the slices are available at the RAN or cell serving the wireless device.

11. The method of claim 9 wherein the area where the slice is not available comprises a single cell.

12. The method of claim 1 wherein a network slice is identified by a Single—NSSAI, S-NSSAI.

13. The method of claim 1 wherein the CN node comprises an Access and Mobility Management Function, AMF.

14. A method performed by a base station and/or a network node for inhomogeneous slice support, the method comprising:
receiving an indication of whether a wireless device supports non-uniform slice availability;
assigning an appropriate Allowed Network Slice Selection Assistance Information, NSSAI, to the wireless device;
if the wireless device supports non uniform slice availability, including in the Allowed NSSAI slices that are not uniformly available within a Registration Area, RA; and
if the wireless device does not support non uniform slice availability, including in the Allowed NSSAI only slices that are uniformly available within the RA.

15. The method of claim 14 further comprising:
controlling the wireless device to provide a reference to a Radio Resource Slice Group, RRSG, at a Radio Resource Control, RRC, Connection establishment.

16. The method of claim 14 further comprising:
verifying that the wireless device used a correct RRSG.

17. The method of claim 14 further comprising:
receiving such an indication and forwarding the indication to a Core Network, CN, serving the wireless device by means of Radio Access Network-Core Network, RAN-CN, signaling.

18. The method of claim 14 wherein Access Stratum, AS, signaling comprises signaling via RRC signaling.

19-24. (canceled)

25. A wireless device for inhomogeneous slice support, the wireless device comprising one or more processors and memory configured to cause the wireless device to:
signal, to a Core Network, CN, node, an indication that the wireless device supports non-uniform slice availability; and
receive an information on how the wireless device may act based on the indicated slice support.

26. (canceled)

27. A node for inhomogeneous slice support, the node comprising one or more processors and memory configured to cause the node to:
receive an indication of whether a wireless device supports non-uniform slice availability;
assign an appropriate Allowed Network Slice Selection Assistance Information, NSSAI, to the wireless device;
if the wireless device supports non uniform slice availability, include in the Allowed NSSAI slices that are not uniformly available within a Registration Area, RA; and
if the wireless device does not support non uniform slice availability, include in the Allowed NSSAI only slices that are uniformly available within the RA.

28. (canceled)
